(19) United States
(12) Patent Application Publication
(10) Pub. No.: US 2020/0333755 A1
(43) Pub. Date: Oct. 22, 2020

(54) CONTROL MODULE FOR A THREE DIMENSIONAL PRINTING SYSTEM

(71) Applicant: HEWLETT-PACKARD DEVELOPMENT COMPANY, L.P., Houston, TX (US)

(72) Inventors: Sergio De Santiago Dominguez, Sant Cugat del Valles (ES); Anna Torrent, Sant Cugat del Valles (ES); Noel Liarte, Sant Cugat del Valles (ES)

(73) Assignee: HEWLETT-PACKARD DEVELOPMENT COMPANY, L.P., Houston, TX (US)

(21) Appl. No.: 16/095,762

(22) PCT Filed: Jul. 1, 2016
(86) PCT No.: PCT/EP2016/065613

§ 371 Date: Oct. 23, 2018

(51) Int. Cl. G05B 19/042; B29C 64/393; B33Y 50/02

(52) U.S. Cl. CPC G05B 19/0421; B29C 64/393; G05B 2219/21039; G05B 2219/25257; G05B 2219/25252; B33Y 50/02

(57) ABSTRACT

An example control module for a three-dimensional (3D) printing system is described having multiple input interfaces, multiple output interfaces and a power supply interface. The power supply interface provides power to at least one of the control module and any devices connected to the control module via the output interfaces. The control module is configured to receive instructions from a central control unit via at least one of the input interfaces and command a range of electromechanical devices via at least one of the output interfaces.

### BACKGROUND

Complex electromechanical products, such as three-dimensional (3D) printing systems, may comprise different subsystems each comprising one or multiple electronic devices. Example electronic devices include a motor, an actuator, a heater, a sensor, a valve etc. The electronic control modules that control each subsystem within the complex product, and their corresponding device(s), may be provided on printed circuit assemblies (PCAs). Each of the individual control module PCAs may be connected to a central control unit PCA, which manages the multiple subsystems. Each subsystem control module may be designed according to its application.

### BRIEF DESCRIPTION OF THE DRAWINGS

Examples of the disclosure will be described with reference to the accompanying drawings, in which:

FIG. 1 shows an example of a multi-purpose control module;

FIG. 2 shows an example of a modular control system incorporating a central control unit and multiple control modules;

FIG. 3 shows an example control module according to FIG. 1 configured to engage a centralised control system;

FIG. 4 shows an example control module according to FIG. 1 configured to engage a distributed control system;

FIG. 5 shows an example control module according to FIG. 1 configured to engage a mixed centralised control system;

FIG. 6 shows an example centralised modular control system;

FIG. 7 shows an example distributed modular control system;

FIG. 8 shows an example mixed modular control system; and

FIG. 9 shows an example non-transitory computer-readable storage medium comprising a set of computer-readable instructions.

### DETAILED DESCRIPTION

In comparative complex products, e.g. one comprising multiple subsystems such as a 3D printer system, each subsystem may be controlled by an individual control module PCA. Certain comparative examples of such a controller layout have employed custom designed control module PCAs for each subsystem. Each subsystem control module, and their corresponding connection to the central control unit PCA, may be different from one another depending on the number and type of device(s) being controlled, bandwidth, and the distance the signals from the central control unit need to traverse until they reach the specific subsystem control module. However, whilst the application-orientated design of the control modules provides for reduced individual PCA cost (by minimising the materials and components incorporated into each control module), there are other costs associated with the custom production schedule, such as time spent designing each control module, and the utilised electrical engineering resources.

The different electromechanical devices within each subsystem of a 3D printer system may employ a similar range of mechanisms, for example motors, sensors, switches and actuators. Certain examples herein provide an alternative, and modular, approach to control module PCAs. In particular, certain examples comprise a generic, multi-purpose control module PCA for each subsystem, which is compatible with a range of input/output bus configurations and capable of controlling a range of devices and their associated mechanisms depending on the subsystem it is installed into. Such a control module may provide supported functionality for each subsystem in a 3D printing system.

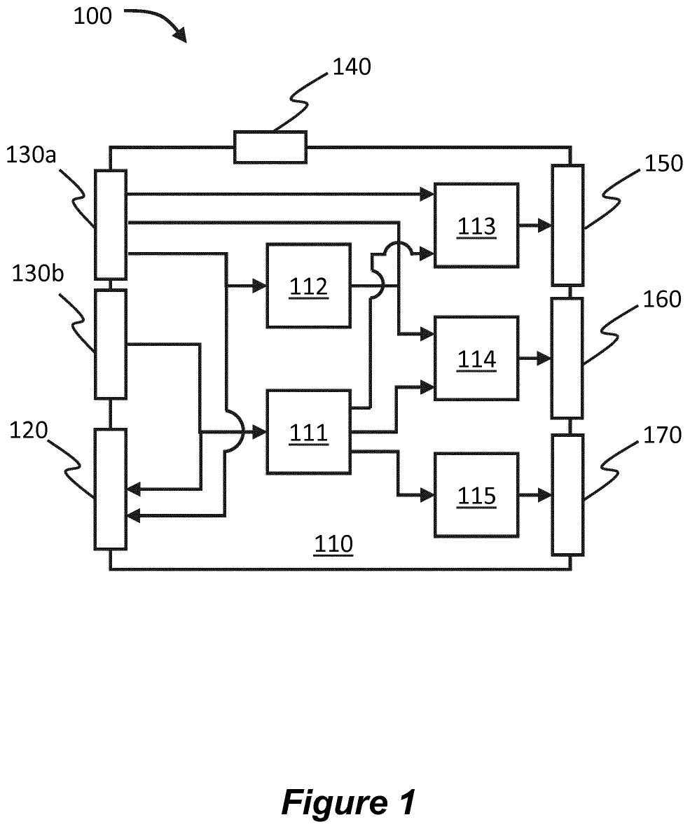

FIG. 1 shows a multi-purpose control module 100 according to an example. The control module 100 may be formed upon a PCA 110 and may also comprise multiple input interfaces 130a, 130b compatible with a range of control bus configurations. The input interfaces may comprise a centralised control interface 130a and a distributed control interface 130b, compatible with corresponding centralised control buses and distributed control buses respectively.

A centralised control connection is intended for applications and devices to be controlled by a central control unit in order to reduce and/or avoid signal delays, such as those related to a distributed control system where several controllers are interfacing and passing information among themselves.

A reduction in signal delay may be sought for systems where there is real-time synchronization between different devices. Centralised control signals may be sent directly from a central control unit to the device drivers, without processing by any intermediate micro-controllers. Centralised control systems are typically faster and more reliable than distributed control systems. However, the increased processing power demanded by the central control unit may result in a lack of scalability.

A distributed control connection is used to control multiple devices/subsystems that may be a greater distance away from the central control unit. High-level instructions are sent from a central control unit to intermediate control module micro-controllers for interpretation/translation. The micro-controllers generate low-level orders for any corresponding local device(s) controlled by the control module. The distributed instruction signals are sent out using a daisy-chain connection between multiple control modules.

The control module 100 also comprises multiple output interfaces 150, 160 capable of controlling, and interfacing with, a range of different electromechanical devices, and any incorporated mechanisms, such as:

low power direct current (DC) motors with a rated current below 2 Amps;
low voltage sensors, e.g. switches;
low current actuators, e.g. switches, to turn on fans or solenoids;
low input voltage analogue sensors, e.g. temperature sensors or pressure sensors; or
a high power motor with a rated current below 8 Amps.

In one example, one output interface 150 is a motor interface configured to control a DC motor via a motor controller 113. Another output interface 160 is configured to connect with a range of low power DC motors, sensors and actuators via an analogue application-specific integrated circuit (ASIC) 114. The control module 100 may also comprise a daisy-chain output interface 120 to forward instruction signals to additional modules.

The control module 100 may also comprise a power supply interface 140 to provide power to at least one of:

the control module components; and
via the output interfaces 150, 160 to each device controlled by the control module 100.

The power supply interface 140 may admit a range of voltages, for example from 12V up to 42V, suitable for powering a range of device mechanisms. For example, the power supply interface 140 may allow the control module 100 to be used with:

motors, for example of 24V or 42V;
programmable logic controller (PLC) electronics operating at 24V; and
a 12V supply from a motherboard to control small sensors.

The control module 100 may further comprise a micro-controller 111 to interpret high-level instructions for distributed control of a subsystem, and a differential receiver 112 and transmitter 115 in order to receive/transmit signals over long distances. The control module 100 may also comprise a micro-controller output interface 170 to forward signals from the differential transmitter 115.

The differential receiver 112 and transmitter 115 of the control module 100 allow the use of both “single-ended” and “differential” signalling systems. Single-ended and differential signalling both transmit information along pairs of conductors/paths, e.g. wires (in certain cases twisted together) or traces on a circuit board.

Single-ended signalling is one method of transmitting signals, and one wire carries a varying voltage that represents the signal, while the other wire is connected to a reference voltage, usually ground. However, the method is prone to signal noise from electromagnetic interference, and so is intended for short distance signalling. The alternative to single-ended signalling is called differential signalling.

Differential signalling uses two complementary signals, and a differential receiver responds to the electrical difference between the two signals, rather than the difference between a single wire and ground. Signals sent over long distances are susceptible to degradation due to the impedance of the transfer medium, especially at high frequencies. The use of a differential signalling system (the combination of a transmitter 115 and a receiver 112) helps maintain the integrity of any signal sent over a longer distance. The differential signalling system also helps reduce noise from electromagnetic interference since any electromagnetic interference tends to affect both conductors identically. The differential receiver 112 detects the difference between the wires, therefore the technique helps reduce electromagnetic noise.

Differential signalling may therefore be used to transmit signals over long distances and singled-ended signals may be used to transmit signals over short distances. Centralised control systems can use both single-ended and differential signals, however typically differential signals are used in distributed control systems.

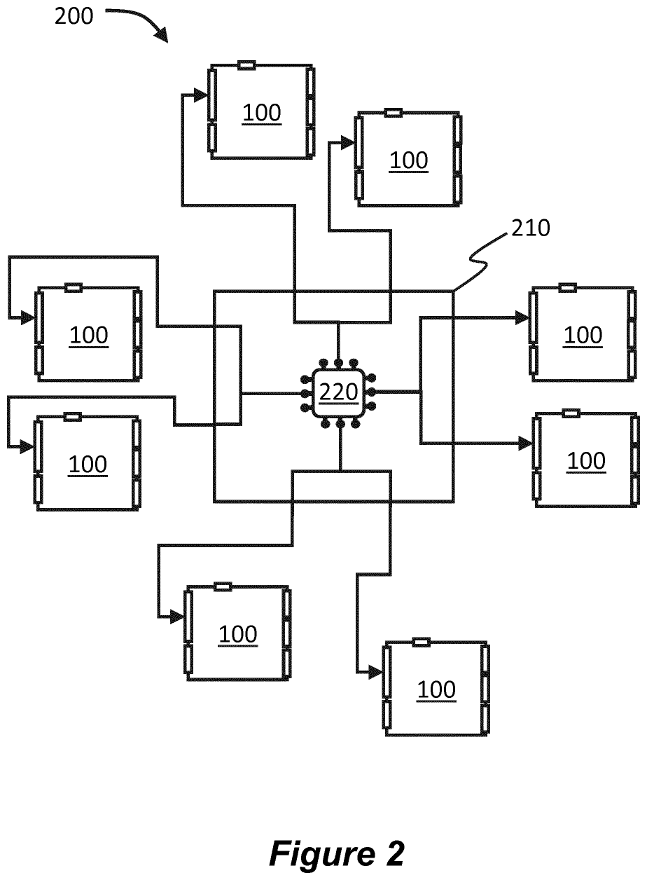

FIG. 2 shows a simplified representation of an example modular control system 200 for controlling multiple electromechanical devices. The modular control system 200 may comprise two or more control modules 100, each connected to a central control unit 210. The central control unit 210 comprises a microprocessor 220 and provides instructions, via either a centralised or a distributed control connection, to each of the control modules 100 connected to it, as will be described in more detail later. Each control module 100 is configured to receive instructions from the central control unit 210 via the appropriate input interface 130a, 130b depending on the type of connection, and command a range of electromechanical devices via the appropriate output interfaces 150, 160.

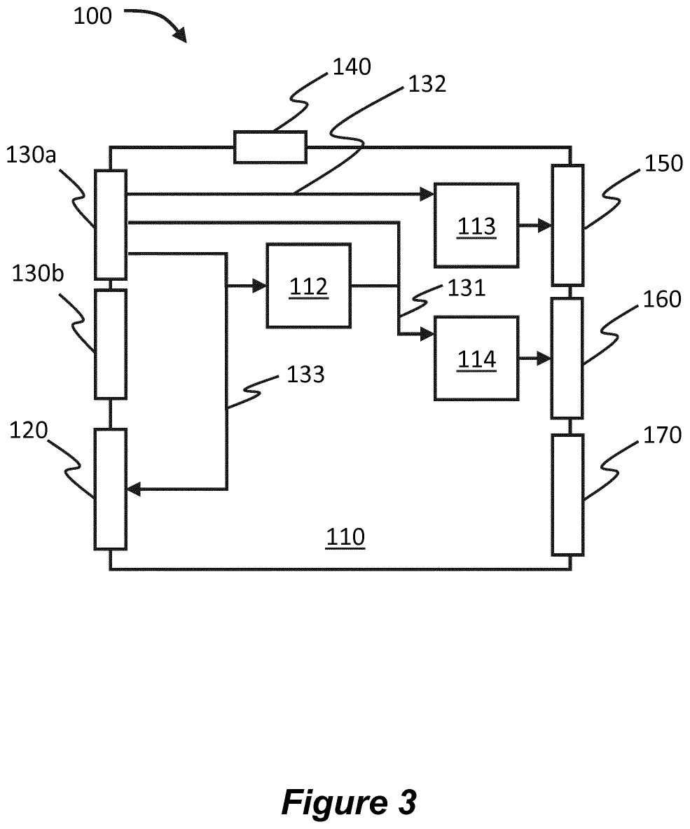

FIG. 3 shows an example of a control module 100 as shown in FIG. 1, operating as a centralised control module and connected with a central control unit 210 via a centralised control bus and corresponding centralised control interface 130a. The components shown in FIG. 1 which are redundant in this scenario are not shown, although are still present in the control module 100.

In a centralised connection, the microprocessor 220 in the central control unit 210 provides instructions across a centralised connection and via a centralised control interface 130a, directly to the motor controller 113 or the ASIC 114 of the control module 100. No additional signal processing/interpretation is carried-out by a micro-controller 111 of a destination control module 100.

The centralised control interface 130a is configured to handle a range of centralised signal inputs, such as:

an Inter-Integrated Circuit (I²C, or I2C) connection;
a general purpose input/out (GPIO) connection;
a Multiple Integrated Circuit Control Interface (MICCI2) single-ended connection; and
a Multiple Integrated Circuit Control Interface (MICCI2) differential connection.

The centralised control bus and corresponding centralised control interface 130a may be connected directly to the motor controller 113 via either of an I2C or GPIO connection 132. The centralised connection interface 130a may be connected to the ASIC 114 via either:

a direct connection 131 from the centralised control interface 130a along a MICCI2 single-ended connection; or
a MICCI2 differential signal 133 converted to a single-ended signal by the differential receiver 112. The MICCI2 differential signal 133 from the centralised control interface 130a may also be passed directly to the daisy-chain output interface 120 for forwarding to another module or component. A centralised control signal outputted from the daisy-chain output 120 of the control module 100 may be received by the centralised control bus interface 130a of the next control module 100 in the chain.

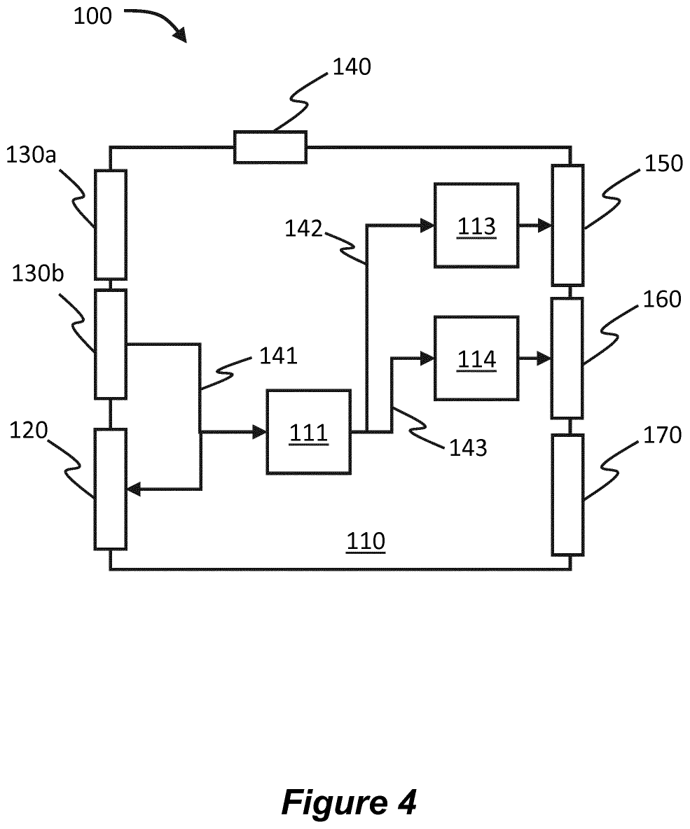

FIG. 4 shows an example of a control module 100 as shown in FIG. 1, engaged with a central control unit 210 via a distributed control bus and corresponding distributed control interface 130b. The components shown in FIG. 1 which are redundant in this scenario are not shown, although are still present in the control module 100.

In a distributed control system, the microprocessor 220 in the central control unit 210 sends high-level signals across a distributed connection to be received by the distributed input interface 130b of a control module 100. The high-level instructions are directed to the control module micro-controller 111 for interpretation/translation via a controller area network bus (CANBUS) connection 141. The micro-controller 111 generates low-level orders for any corresponding local device(s) controlled by the control module 100. The ASIC 144 is configured to receive MICCI2 single-ended low-level signals from the micro-controller 111, via a direct connection 143, and forward them to the output interface 160.

Low-level instructions, sent across GPIO or I2C buses, may also be sent to the motor controller 113 via a direct connection 142 from the micro-controller 111.

Signals may also be output, automatically, to the daisy-chain output interface 120 via a direct CANBUS connection 141 from the distributed control interface 130b. A differential signal, outputted from the daisy-chain output 120 of a control module 100 may be received by the distributed control interface 130b of the next control module 100 in the chain.

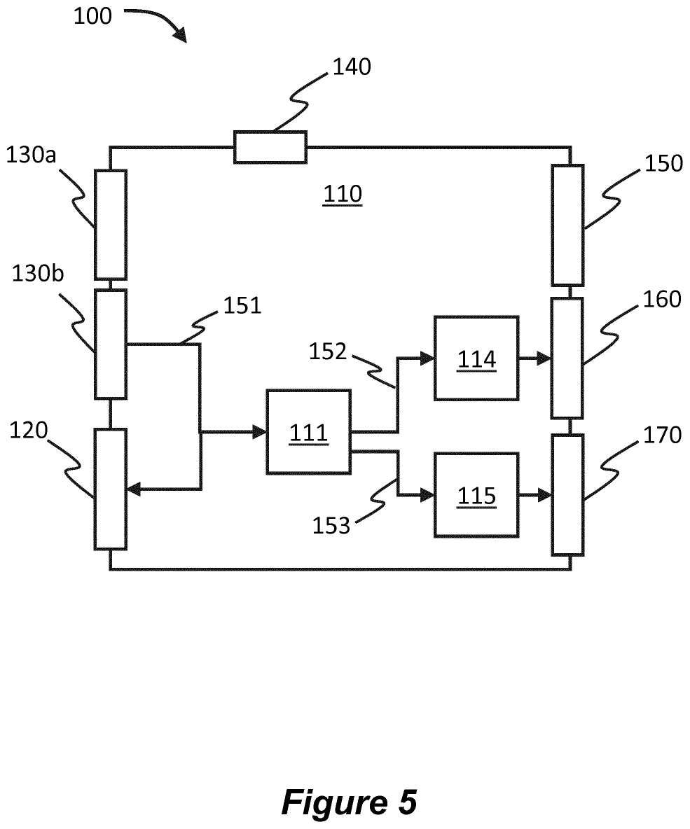

FIG. 5 shows an example of a “mixed” control system module 100 configured to operate as a distributed control module, and also control additional control modules 100 by acting as a “limited” central control unit. As shown before in FIG. 4, the control module 100 is engaged with a central control unit 210 via the distributed control bus and corresponding distributed control interface 130b. The micro-controller 111 is connected via a CANBUS connection 151 to the distributed control interface 130b (which is also directly connected to the daisy-chain output interface 120). In this example, the micro-controller 111 receives high-level signals via the CANBUS connection 151 from the distributed control interface 130b, and translates them into low level instructions. The low level instructions can be sent to the ASIC 114 and the differential transmitter 115 via a MICCI2 single ended connection 152, 153. The ASIC 114 may control any device connected to the corresponding output interface 160. The differential transmitter 115 may translate the MICCI2 single ended signal into a MICCI2 differential signal, and output it via the micro-controller output interface 170. The outputted MICCI2 differential signal may then be used to control another control module 100 via the centralised control interface 130a of the other control module 100.

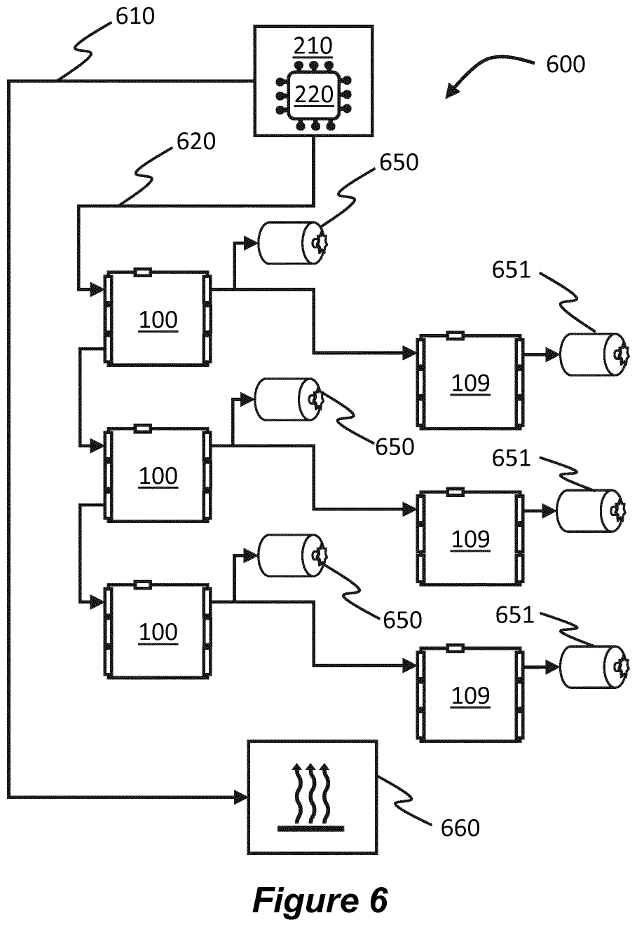

FIG. 6 shows an example of a centralised control system 600 comprising a central control unit 210 and multiple control modules 100. Each of the control modules 100 is connected to the central control until 210 by a centralised MICCI2 differential connection 620, therefore each control module 100 does not utilise a micro-controller 111 to translate high level instructions to low level instructions. The MICCI2 differential connection 620 arrives at each control module 100 via the centralised control bus and corresponding control interface 130a, and exits via the daisy-chain output interface 120 to reach the next control module 100 in the chain. Each control module 100 controls a device 650 directly via one of the output interfaces 150, 160. In one example, the device 650 engaged with a control module 100 may be one of:

a direct current (DC) motor;
a digital sensor;
an analogue sensor; or
a quad encoder.

In the given example, each control module 100 is also connected via one of the output interfaces 150, 160 to “slave” control module 109. The slave control modules 109 are identical to a standard control module 100 of FIG. 1. Each slave control module 109 receives signals from one of the output interfaces 150, 160 of the corresponding “master” control module 100, and controls a corresponding connected device 651. In the example shown in FIG. 6, there is also a heater system 660, connected directly to the central control unit 610 by a controller area network bus (CANBUS) 610.

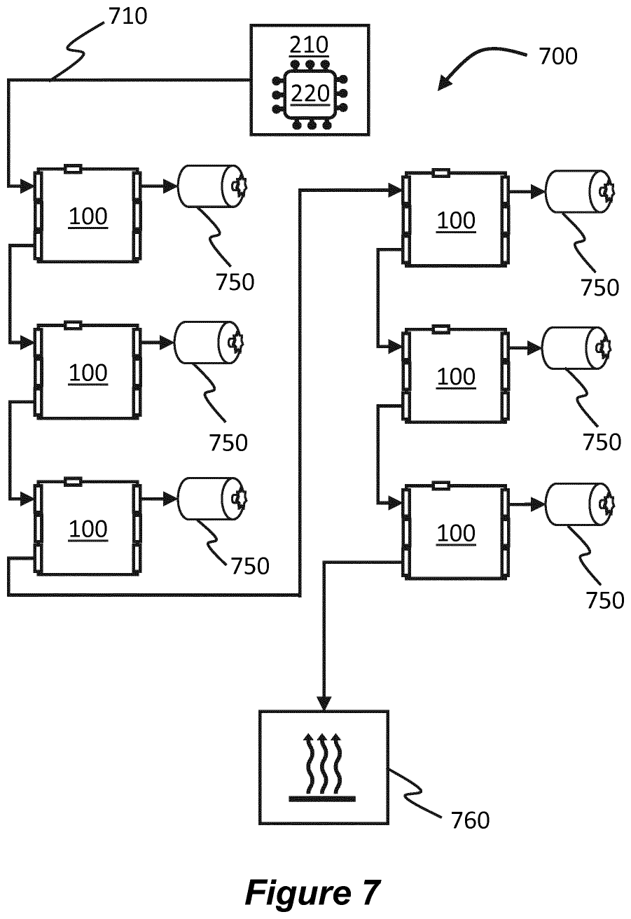

FIG. 7 shows an example of a distributed control system 700 comprising a central control unit 210 and multiple control modules 100. Each of the control modules 100 is connected to the central control until 210 by a distributed CANBUS connection 710, therefore each control module 100 employs a micro-controller 111 to translate high level instructions to low level instructions. The CANBUS connection 710 arrives at each control module 100 via the distributed control bus and corresponding interface 130b, and exits via the daisy-chain output interface 120 to reach the next control module 100 in the chain. Each control module 100 controls a device 750 directly via one of the output interfaces 150, 160. In one example, the device 750 engaged with a control module 100 may be one of:

a direct current (DC) motor;
a digital sensor;
an analogue sensor; or
a quad encoder.

In the example shown in FIG. 7, there is also a heater system 760, connected by a CANBUS connection from the daisy-chain output interface 120 of the last control module 100 in the daisy-chain.

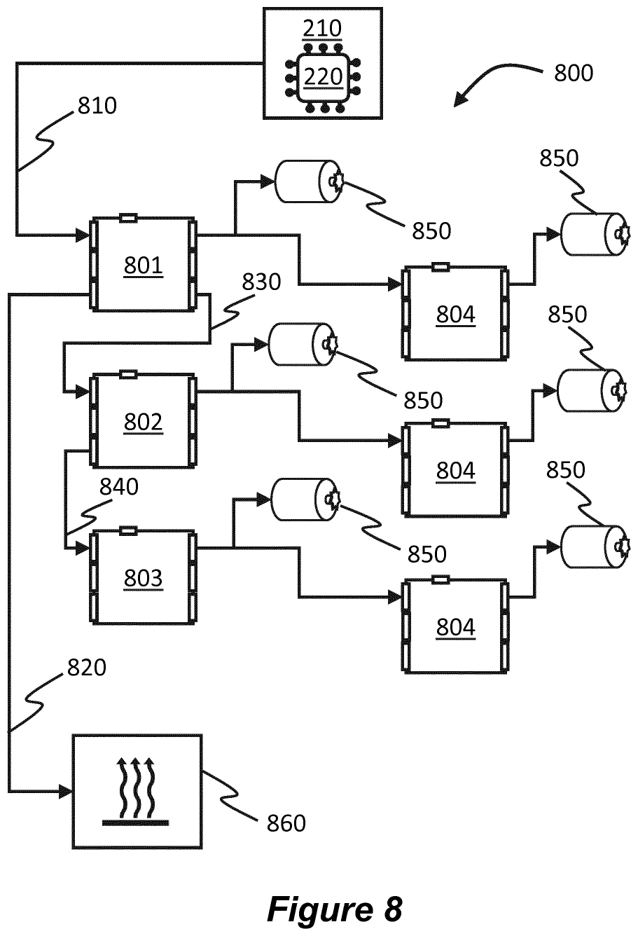

FIG. 8 shows an example of a mixed (distributed and centralised) control system 800 comprising a central control unit 210 and multiple control modules 801, 802, 803, 804. Each of the control modules shown 801, 802, 803, 804 is identical to the standard control module 100 of FIG. 1. The first control module 801 in the chain is connected via a distributed control interface 130b to the central control system 210 by a CANBUS connection 810. The first control module 801 acts as a distributed control module and employs a micro-controller 111 to translate high level instructions to low level instructions. The first control module 801 is connected to:

a heater unit 860 via a CANBUS connection 820 from the daisy-chain output interface 120 of the first control module 801;
a device 850 via one of the output interfaces 150, 160 of the first control module 801;
a slave control module 804 via one of the output interfaces 150, 160 of the first control module 801; and
a second control module 802 in the chain via a MICCI2 connection 830 between the micro-controller output interface 170 of the first control module 801 and the centralised control interface 130a of the second control module 802 in the chain.

The second control module 802 in the chain receives instructions at the centralised control interface 130a via a MICCI2 connection 830 from the first control module 801. The second control module is connected to:

a device 850 via one of the output interfaces 150, 160 of the second control module 802;
a slave control module 804 via one of the output interfaces 150, 160 of the second control module 802; and
a third control module 803 via a MICCI2 connection 840 between the daisy-chain output interface 120 of the second control module 802 and the centralised control interface 130a of the third control module 803 in the chain.

The third control module 803 is connected to:

a device 850 via one of the output interfaces 150, 160 of the third control module 803; and
a slave control module 804 via one of the output interfaces 150, 160 of the third control module 803.

Each slave control module controls a device 850 via one of the output interfaces 150, 160 of the slave control module 804.

In one example, the device 850 controlled directly by each control module 801, 802, 803, 804 via one of the output interfaces 150, 160 may be one of:

a direct current (DC) motor;
a digital sensor;
an analogue sensor; or
a quad encoder.

The second 802 and third 803 control modules, along with each of the slave control modules 804, act as centralised control modules and are controlled centrally via their respective centralised control interfaces 130a, i.e. the micro-controller are not employed to translate/interpret high level signals into low lever signals. Instead, instructions are provided directly to each control module 802, 803, 804.

As described above, both centralised and distributed connections may be used to control multiple control modules 100 linked together in a “daisy chain”, with instructions that may be transmitted over long distances from the central control unit 210. In a distributed connection, high-level instructions are sent from microprocessor 220 of the central control unit 210 across the distributed connection. The high-level instructions are directed to the control module micro-controller 111 for interpretation/translation. The micro-controller 111 generates low-level orders for any corresponding local device(s) controlled by the control module 100 through the motor control 113 and motor interface 150, and/or the ASIC 114 and output interface 160. As described in regard to FIG. 5, low-level order may also be provided from the micro-controller 111 to the micro-controller output interface 170.

The instruction signals may include a control module address identifying which control module 100 in the daisy-chain a given instruction is for. The instruction signals received from the central control unit 210 are automatically forwarded from the first control module in the chain to each other control module in the daisy-chain, and each control module follows the instructions specifically addressed to them.

Certain examples described herein are directed towards a control module 100 that can be replicated and used to control a range of different devices found in a complex electromechanical product, such as a 3D print system. Instead of having to design, and test, customised control boards for each device in a complex product, a single generic and multi-purpose control module 100 can be mass-produced that is capable of controlling all of the devices present in a given 3D print system. Whilst each individual control module 100 may comprise more components and/or materials than a customised control module, benefits may be provided by way of a single design and reduced or simplified testing phase.

In use, given the multiple input interfaces 130a, 130b and output interfaces 120, 150, 160, 170 provided on each control module 100, it is anticipated that for any given role, i.e. depending on which device the control module 100 is assigned to, there will be a redundancy of features and interfaces on the control module 100. However, the over-provisioned control module 100 of the present disclosure will be able to handle any input, and provide any output, in order to drive any of the different devices incorporated in a complex product such as a 3D print system.

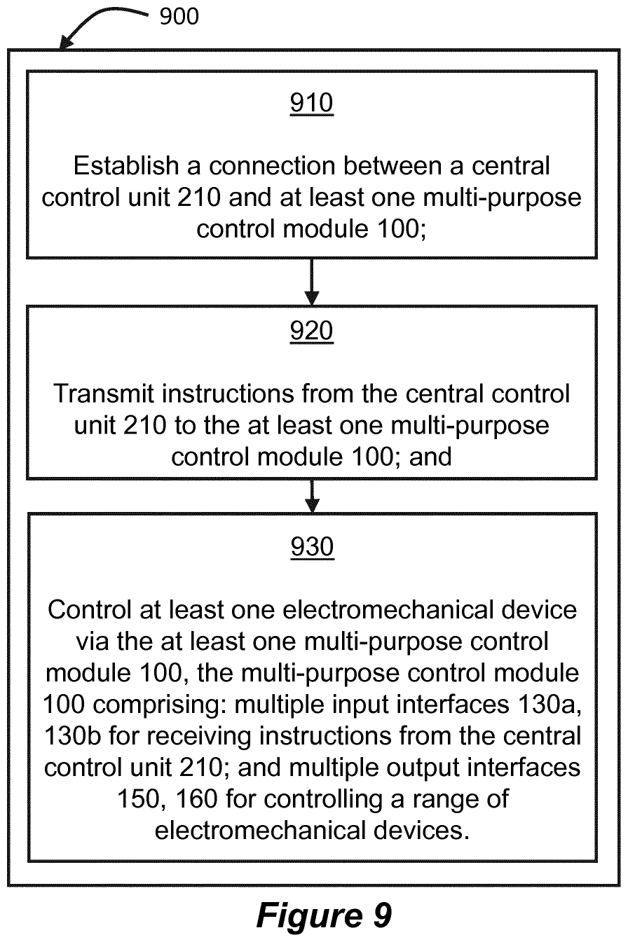

As shown in FIG. 9, there is also provided an example of a non-transitory computer-readable storage medium 900 comprising a set of computer readable instructions (blocks 910 to 930) which, when executed by at least one processor, cause the processor to perform a method according to the examples described herein.

Block 910 describes establishing a connection between a central control unit 210 and at least one multi-purpose control module 100. Block 920 describes transmitting instructions from the central control unit 210 to the at least one multi-purpose control module 100. Block 930 describes controlling at least one electromechanical device via the at least one multi-purpose control module 100. The multi-purpose control module 100 comprises:

multiple input interfaces 130a, 130b for receiving instructions from the central control unit 210; and
multiple output interfaces 150, 160 for controlling a range of electromechanical devices.

In one example, the at least one processor may form part of the central control unit 210 in FIG. 2. The computer readable instructions 900 may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

The above are to be understood as illustrative examples, and further examples are envisaged. For example, the centralised control input buses may comprise at least one of a general purpose input/out (GPIO); Multiple Integrated Circuit Control Interface Differential (MICCI2 Diff); and Multiple Integrated Circuit Control Interface (MICCI2). The distributed control buses may comprise at least one of a controller area network bus (CANBUS); a universal asynchronous receiver/transmitter (UART); and a universal serial bus (USB). The input interface may also be configured to accept system signals and sideband signals.

It is to be understood that any feature described in relation to any one example may be used alone, or in combination with other features described, and may also be used in combination with features of any other of the examples, or any combination of any other of the examples. Furthermore, equivalents and modifications not described above may also be employed without departing from the scope of the disclosure, which is defined in the accompanying claims.

1. A control module for a three-dimensional (3D) printing system, the module comprising:
multiple input interfaces;
multiple output interfaces; and
a power supply interface to provide power to at least one of the control module and any devices via the output interfaces;
wherein the control module is configured to:
receive instructions from a central control unit via at least one of the input interfaces; and
command a range of electromechanical devices via at least one of the output interfaces.

2. The control module according to claim 1, wherein the input interfaces comprise:
at least one centralised control bus; and
at least one distributed control bus.

3. The control module according to claim 1, comprising:
a daisy-chain output interface.

4. The control module according to claim 1, comprising:
a micro-controller output interface.

5. The control module according to claim 1, comprising:
a micro-controller;
a differential receiver;
a motor controller;
an application-specific integrated circuit (ASIC); and
a differential transmitter.

6. The control module according to claim 1, wherein the output interfaces are configured to control at least one of:
a low power DC motor driver, and
a high power DC motor driver.

7. The control module according to claim 1, wherein
the power supply interface is configured to accept a range of voltage inputs.

8. A modular control system for controlling a three-dimensional (3D) printing system, the modular control system comprising:
a central control unit comprising a microprocessor; and
two or more multi-purpose control modules connected to the central control unit, each multi-purpose control module comprising:
multiple input interfaces; and
multiple output interfaces;
wherein each multi-purpose control module is configured to:
receive instructions from the central control unit via any one of the multiple input interfaces; and
command a range of electromechanical devices via at least one of the multiple output interfaces.

9. The modular control system according to claim 8, wherein the central control unit is engaged with:
at least one multi-purpose control module via a distributed control bus; and
at least one multi-purpose control module via a centralised control bus.

10. The modular control system according to claim 8, wherein at least two multi-purpose control modules are engaged with each other via a daisy-chain connection.

11. A non-transitory computer-readable storage medium comprising a set of computer-readable instructions stored thereon which, when executed by at least one processor, cause the at least one processor to:
establish a connection between a central control unit and at least one multi-purpose control module;
transmit instructions from the central control unit to the at least one multi-purpose control module; and
control at least one electromechanical device via the at least one multi-purpose control module, the multi-purpose control module, comprising:
multiple input interfaces for receiving instructions from the central control unit; and
multiple output interfaces for controlling a range of electromechanical devices.

12. The non-transitory computer-readable storage medium according to claim 11, wherein the at least one established connection is a centralised control connection.

13. The non-transitory computer-readable storage medium according to claim 11, wherein the at least one established connection is a distributed connection, and the at least one processor is caused to:
transmit high-level instructions from a central control unit to at least one multi-purpose control module; and
translate the high-level instructions in to low-level instructions to control any electromechanical device(s) connected to the at least one multi-purpose control module.

14. The non-transitory computer-readable storage medium according to claim 11, wherein the instructions cause the at least one processor to: transmit instructions from a central control unit, via at least a first multi-purpose module to a second multi-purpose module, across a daisy-chain connection.

15. The non-transitory computer-readable storage medium according to claim 11, wherein the instructions further cause the at least one processor to:
utilise differential signalling to transmit any instructions from the central control until to a control module.
